(19) United States
(12) Patent Application Publication
(10) Pub. No.: US 2016/0132895 A1
(43) Pub. Date: May 12, 2016

(54) METHOD OF INTERNET REAL-TIME CUSTOMER SERVICE

(71) Applicant: CHIEN-CHUNG YUEH, NEW TAIPEI CITY (TW)

(72) Inventor: CHIEN-CHUNG YUEH, NEW TAIPEI CITY (TW)

(21) Appl. No.: 15/000,509

(22) Filed: Jan. 19, 2016

Related U.S. Application Data
(63) Continuation-in-part of application No. 14/480,818, filed on Sep. 9, 2014.

(51) Int. Cl. G06Q 30/00; H04L 29/06

(52) U.S. Cl. CPC G06Q 30/016; H04L 65/1069

(57) ABSTRACT

The present invention provides a method of Internet real-time customer service, including the steps of: providing an online customer service system connected to Internet; providing an exclusive login data to the website operator registering to the online customer service system; for customer service staff of website operator using the exclusive login data to log in to the online customer service system for the online customer service system to enable customer service staff of website operator able to monitor the website; and when visitor visiting the website, the online customer service system providing a plurality of interaction channels between the customer service staff and the visitor as the basis of interaction so that the customer service staff and the visitor able to select from a plurality of interaction channels for interacting with each other.

### REFERENCE TO RELATED APPLICATIONS

This Application is being filed as a Continuation-in-Part application of Ser. No. 13/480,818, filed on 25 May 2012, currently pending.

### BACKGROUND OF THE INVENTION

1. Field of the Invention

The present invention relates to the field of customer service techniques, and in particular to a method of real-time customer service applicable to Internet.

2. The Related Arts

The conventional website consumption is often oriented toward the consumer in a unidirectional manner. If the consumer (namely a visitor to the website) does not initiate contact with website operator, the website operator has no way to obtain the information of the consumer. As most consumers leave the website after browsing, the website operator has no opportunity or other means to provide appropriate assistance or answer in a timely fashion. This lack of flexibility makes the majority of potential consumers left unsatisfied and renders the website mostly inactive.

It is, therefore, imperative to devise a method to allow the website operator to initiate interaction with visitors who visit the website and browse the web pages so as to provide assistance, answer questions and offer explanation and services.

### SUMMARY OF THE INVENTION

An object of the present invention is to provide a method of Internet real-time customer service by providing an online customer service system and a plurality of related steps so that a website operator can initiate contact with the website visitor to provide interactions for assistance and services, whereby the website can be invigorated to assist the website operator to turn a potential customer (a website visitor) into an actual customer.

To achieve the above object, the present invention provides a method of Internet real-time customer service, comprising the steps of: (a) providing an online customer service system connected to Internet; (b) providing exclusive login data to a website operator registering to the online customer service system; (c) customer service staff of the website operator using the exclusive login data to log in to the online customer service system for the online customer service system to enable the customer service staff of the website operator to monitor the website; and (d) when a visitor visits the website, the online customer service system providing a plurality of interaction channels between the customer service staff and the visitor as the basis of interaction so as to enable the customer service staff and the visitor to select from a plurality of interaction channels for interacting with each other.

In this manner, the website operator and the customer service staff can initiate contact with the website visitor to provide interactions for assistance and services. In this manner, the website can be invigorated to assist the website operator to turn a potential customer (a website visitor) into an actual customer.

To make the technical solution of the embodiments according to the present invention clearly understood, a brief description of the drawings that are necessary for the illustration of the embodiments will be given as follows. It is understood that the drawings and the embodiments are only for illustrative purpose, instead of restrictive.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1A is a schematic view showing the structure of an embodiment of the present invention;

FIG. 1B is a schematic view showing the login source code of an embodiment of the present invention;

FIG. 1C is a schematic view showing the online customer service system embedded into the website operator's web page;

FIG. 2 is a flowchart of the method according to the present invention; and

FIGS. 3A and 3B are the schematic views showing merging the virtual image and the real image in the video frame of the handheld device.

### DETAILED DESCRIPTION OF THE PREFERRED EMBODIMENTS

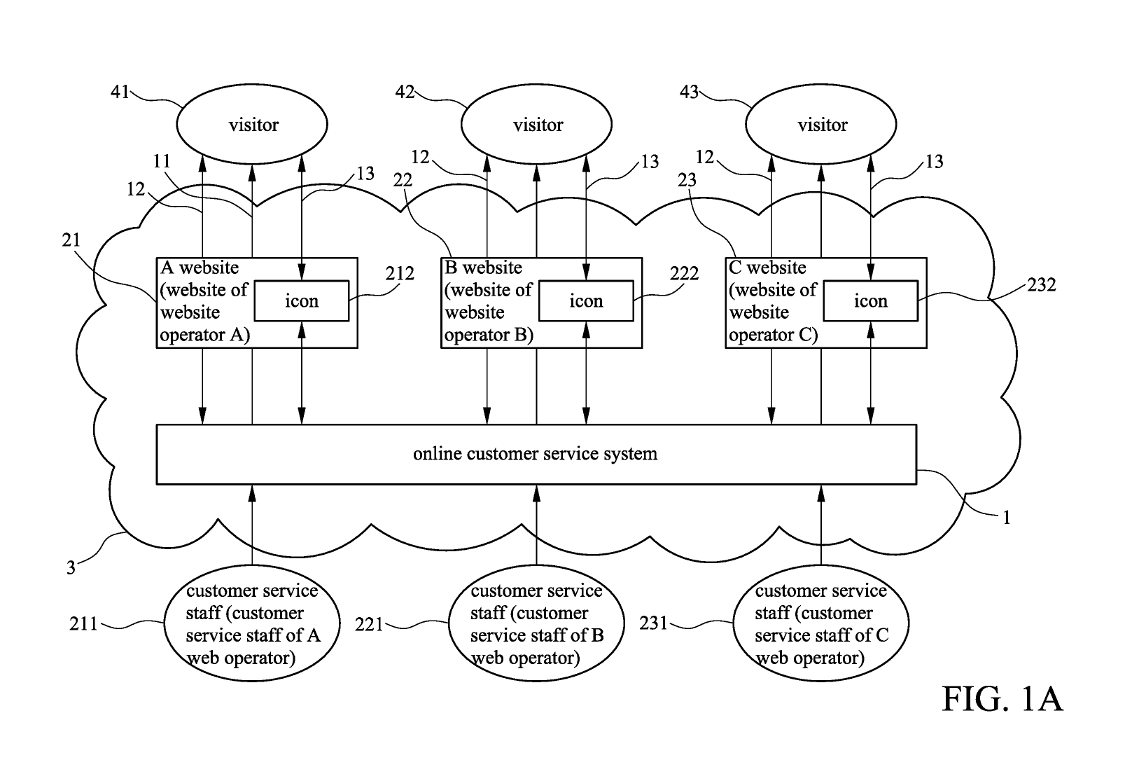

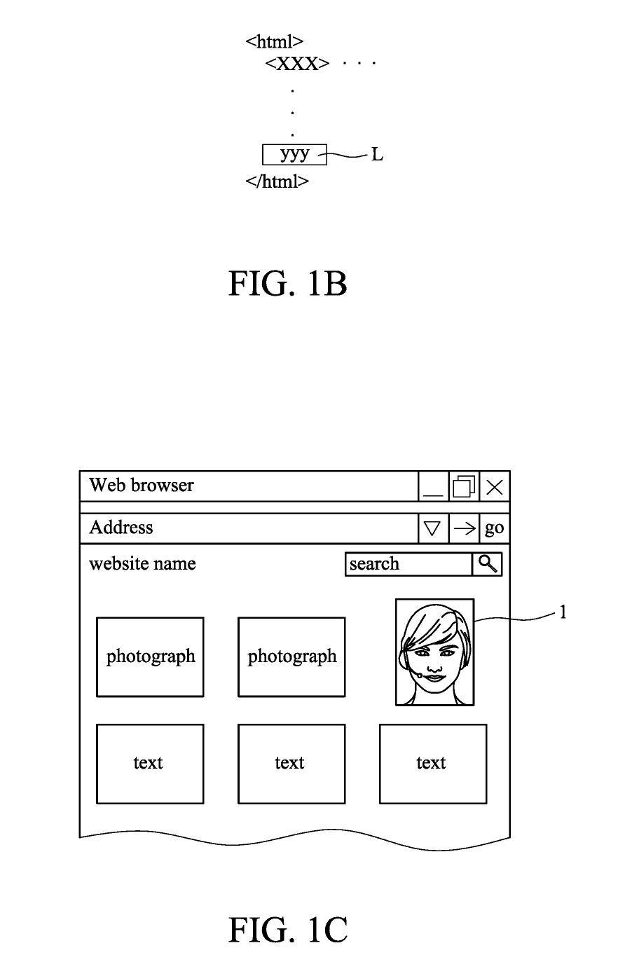

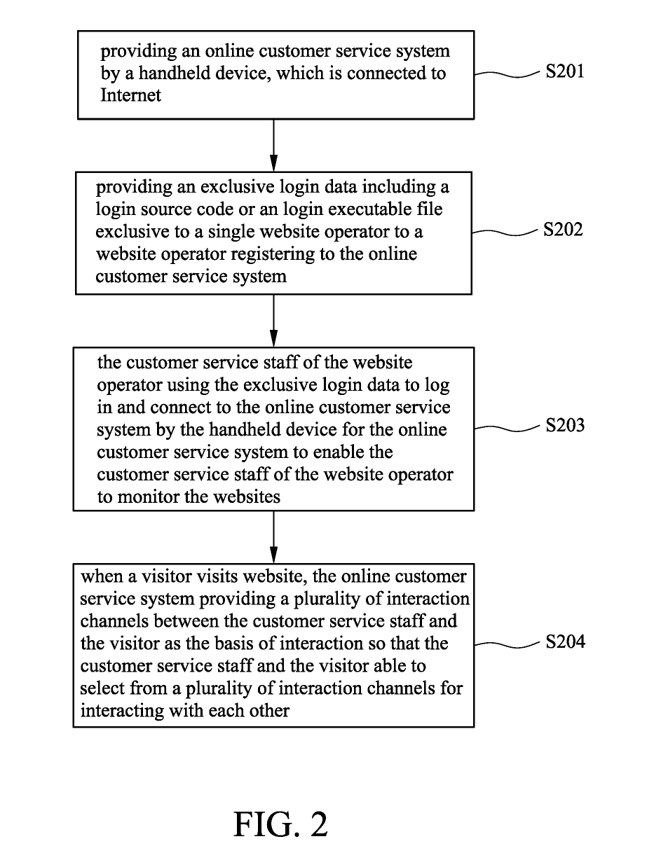

The present invention provides a method of Internet real-time customer service. FIG. 1A shows, for illustrative purpose, an online customer service system 1, which is capable of supporting a plurality of website operators to log in simultaneously, as well as supporting a plurality of customer service staff from a single website operator to log in to interact with visitors, or supporting a plurality of visitors to interact with the same customer service staff from a website operator. The present invention does not impose any restriction in this respect. Furthermore, the online customer service system 1 of the present invention is edited by any web page programming languages such as C++ or SQL and the codes edited by the web page programming languages are called web page program codes, as shown in FIG. 1B. In addition, since the online customer service system 1 is a format of web page as shown in FIG. 1C; therefore, it can be shown and performed on any electronic device able to connect to Internet, such as, desktop computer, notebook computer, or handheld device, wherein the handheld device includes a mobile computing device, a portable computing device, a smart phone or a tablet computer. The present invention does not impose any restriction in this respect.

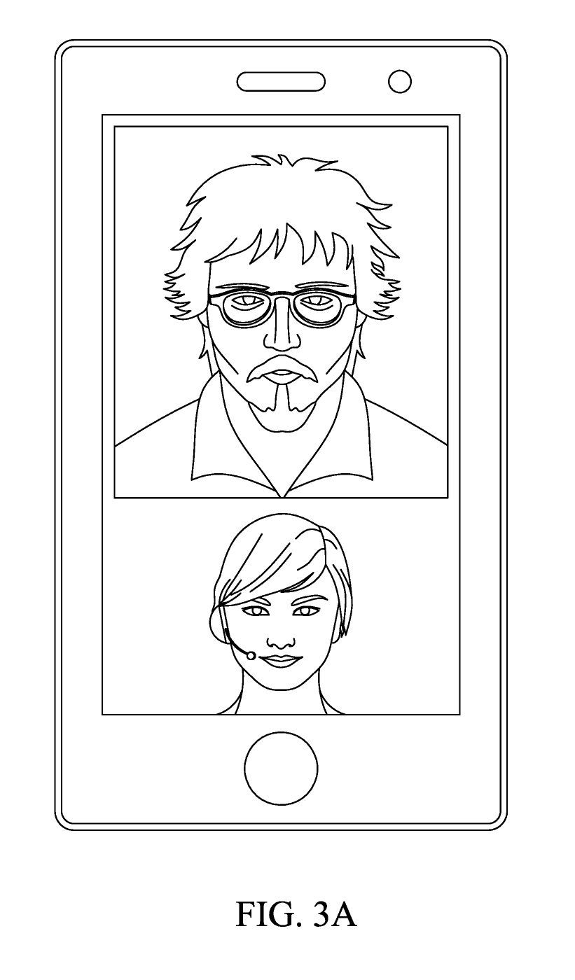

Referring to FIGS. 1A and 2, the method of Internet real-time customer service comprises the following steps:

S201: providing an online customer service system 1 by a handheld device, which is connected to Internet 3.

S202: providing an exclusive login data (not marked with a reference numeral but will be described in details later) including a login source code or an login executable file exclusive to a single website operator to a website operator registering to the online customer service system 1. Furthermore, the login source code can be easily edited for other website operators since the login source code is a simple instruction set. After the website operator adds the login source code to the website operator's own source code of web page (for example, to the second last line of the source code of web page, which is the line of “yyy” as shown in FIG. 1B, and remaining a separate line), the website operator logs in and connects to online customer service system 1 by the handheld device for the first time. In details, the website operators hope that they can interact with the visitor when the visitor is browsing the web page belong to the website operator. Therefore, the website operators can add the login source code to source code of their web page so as to connect to and log in to the online customer service system 1. In other words, the website operators can connect to and log in to the online customer service system 1 through their web page since the online customer service system 1 is embedded into their web page, as shown in FIG. 1C, wherein the online customer service system 1 is embedded into the website operator's web page by the format of the photograph. Therefore, the online customer service system 1 enables the customer service staff of the website to monitor the website, and the website operator can use the web page to directly log in to the online customer service system 1 subsequently, for example, by inputting account and password given during registration. The second and subsequent logins to the online customer service system 1 can all be conducted in this manner. In other words, the website operator does not need to install any software or application in the electronic device such as smart phones or personal computers. In addition to the web page login, the website operator can log in to the online customer service system by executing the login executable file (not marked with a reference numeral) but not need to input account and password. Alternatively, the website operator can set account and password for logging in to the online customer service system 1 after executing the login executable file. That is, the login executable file represents a link of connecting to the online customer service system 1.

S203: the customer service staff of the website operator (website operators A, B, C and customer services staff 211, 221, 231) using the exclusive login data to log in and connect to the online customer service system 1 by the handheld device for the first time so that the online customer service system 1 can enable the customer service staff of the website operator to monitor the activities on the websites (A website 21, B website 22, C website 23 from website operators A, B, C) by the handheld device, for example, to know any visitor browsing the website and which page the visitor currently browsing, and so on.

S204: when visitors visit the website (A website 21, B website 22, C website 23) from Internet 3, the online customer service system 1 provides a plurality of interaction channels (first interaction channel 11, second interaction channel 12, third interaction channel 13) between the customer service staff and the visitors 41-43 as the basis of interaction so that the customer service staff and the visitor can select from the plurality of interaction channels 11-13 for interacting with each other.

To simplify the description, the following description uses the website operator A (A website 21, customer service staff 211 of website operator A) as an exemplary embodiment.

According to the present embodiment, the interaction channels include a first interaction channel 11, a second interaction channel 12 and third interaction channel 13. The first interaction channel 11 is for the customer service staff 211 of the website operator A to initiate interaction with a visitor 41 of A website 21 by issuing an interaction invitation. The interaction invitation is issued through the format of dialog box to the visitor 41, and the online customer service system 1 waits for the response from the visitor 41. When the visitor 41 agrees to accept the interaction invitation, the online customer service system 1 automatically switches to the second interaction channel 12, and the second interaction channel 12 is for the customer service staff 211 of the website operator A to interact with the visitor 41. The interaction includes a plurality of interaction mechanisms, and the customer service staff 211 of the website operator A and the visitor 41 can select at least one from the plurality of interaction mechanisms to conduct interaction.

The third interaction channel 13 is established in A website 21 of the website operator A by the online customer service system 1 in a format of an icon 212. When the visitor 41 visiting A website 21 clicks on the icon 212, the online customer service system 1 allows the customer service staff 211 and the visitor 41 to conduct interaction. The interaction includes a plurality of interaction mechanisms, and the customer service staff 211 of the website operator A and the visitor 41 can select at least one from the plurality of interaction mechanisms to conduct interaction. The third interaction channels 13 for B website 22 and C website 23 are also established in B website 22 and C website 23 by the online customer service system 1 in a format of an icon 222, 232, respectively.

The aforementioned interaction mechanisms include: text, audio, image, video, file transfer, customer service staff transfer real time and real time virtual image and real image merging on a video frame. The text of the interaction mechanisms includes real time language interpretation between the customer service staff and the visitor. The audio of the interaction mechanisms includes auto play voice message from the visitor on the handheld device of the customer service staff. The customer service staff transfer real time of the interaction mechanism includes real time text transfer from the handheld device of one customer service staff to the handheld device of another customer service staff. The customer service staff and the visitor can select one or more from the plurality of interaction mechanisms to conduct interaction.

In addition, the online customer service system 1 further includes at least a database (not shown). The online customer service system 1 can record and store the IP address of the website visitor and the interaction contents through the interaction mechanism to the database. As mentioned above, the real image includes an image of the visitor on the video frame and the virtual image includes an image of at least one object stored in the database.

The customer service staff 211, 221, 231 of the present invention can log in to and use the online customer service system 1 through all types of computers, such as notebook computer, handheld device or desktop computer. The visitors 41, 42, 43 can visit the website through any electronic device able to connect to Internet, such as, desktop computer, notebook computer, tablet computer, or smart phone. The customer service staff can also interact with the visitors through handheld device.

When is use, the online customer service system 1 provides the following functions to the customer service staff: visitor dialog, internal dialog among customer service staff, customer management, customer service management, accesses to the record center of aforementioned database, real time language interpretation between the customer service staff and the visitor, auto play voice message, customer service staff transfer real time, and so on. When the visitor 41 visits A website 21 of website operator A, the online customer service system 1 sends a message indicating visitor arrival to the customer service staff 211. Therefore, the customer service staff 211 can send an inquiry message through the first interaction channel 11 to the visitor 41, and the inquiry message will appear on the electronic device of the visitor 41 in a dialog box, with contents, such as, “Dear Customer, how may I help you? ‘Start Conversation’ or ‘Maybe Next Time’” By initiating the interaction, when the visitor 41 selects ‘Start Conversation’, the system switches to the second interaction channel 12 so that the customer service staff 211 and the visitor 41 can start to interact. The interaction includes: text, audio, image, video and file transfer. When the customer service staff 211 is temporarily unavailable, the online customer service system 1 also provides the function of settable online status, such as, online or temporarily unavailable, so that the visitor 41 can act accordingly, such as, leaving message to the customer service staff 211 for the customer service staff 211 to respond when the customer service staff 211 becomes available again. The customer service staff 211 can edit and store visitor data, for example, editing name to the visitor 41 showing only IP address, editing and assigning to different groups, editing phone number, email address, and so on. Also, a plurality of customer service staff from the same website operator can conduct internal dialog or meeting through the online customer service system 1.

As mentioned above, the function of real time language interpretation between the customer service staff 211 and the visitor 41 can auto transfer according to the location of the visitor 41 and the customer service staff 211 or according to the language installed in the electronic device. That is, after the online customer service system 1 receives the texts sent from the visitor 41, it can transfer the texts inputted by the visitor 41 in one language to the texts inputted by the customer service staff 211 in another language, vice versa. For example, if the visitor 41 inputs the texts in the electronic device in English and the customer service staff 211 inputs the texts in the electronic device in Chinese, the online customer service system 1 will translate the texts sent by the visitor 41 from English to Chinese in the electronic device for the customer service staff 211 and translate the texts sent by the customer service staff 211 from Chinese to English in the electronic device for the visitor 41. Alternatively, if the visitor 41 locates in American and the customer service staff 211 locates in Japan, the online customer service system 1 will translate the texts sent by the visitor 41 from English to Japanese in the electronic device for the customer service staff 211 and translate the texts sent by the customer service staff 211 from Japanese to English in the electronic device for the visitor 41. Therefore, the interactions between the visitor 41 and the customer service staff 211 are more convenient.

In addition, the function of auto play voice message can auto play the voice message left by the visitor 41 in the electronic device of the customer service staff 211 when the customer service staff 211 is temporarily unavailable. Therefore, when the customer service staff 211 comes back, he or she can immediately obtain the voice message and further interact with the visitor 41.

Furthermore, the function of customer service staff transfer real time can transfer from current customer service staff 211 to another customer service staff 221 or service staff 231 real time. In details, since the online customer service system 1 is capable of supporting a plurality of website operators A, B, C to log in simultaneously, as well as supporting a plurality of customer service staff 211, 221, 231 from a single website operator to log in to interact with visitors 41; therefore, the online customer service system 1 can transfer from current customer service staff 211 to another customer service staff 221 or customer service staff 231 real time when the visitor 41 needs to interact with another customer service staff 221 or customer service staff 231.

Moreover, as aforementioned function, the customer service staff transfer real time of the interaction mechanism includes real time text transfer from the electronic device of one customer service staff to the electronic device of another customer service staff. Therefore, another customer service staff 221 or customer service staff 231 can immediately receive the text which aforementioned customer service staff 211 interacts with the visitor 41 in the electronic device so as to interact based on the text with the visitor 41.

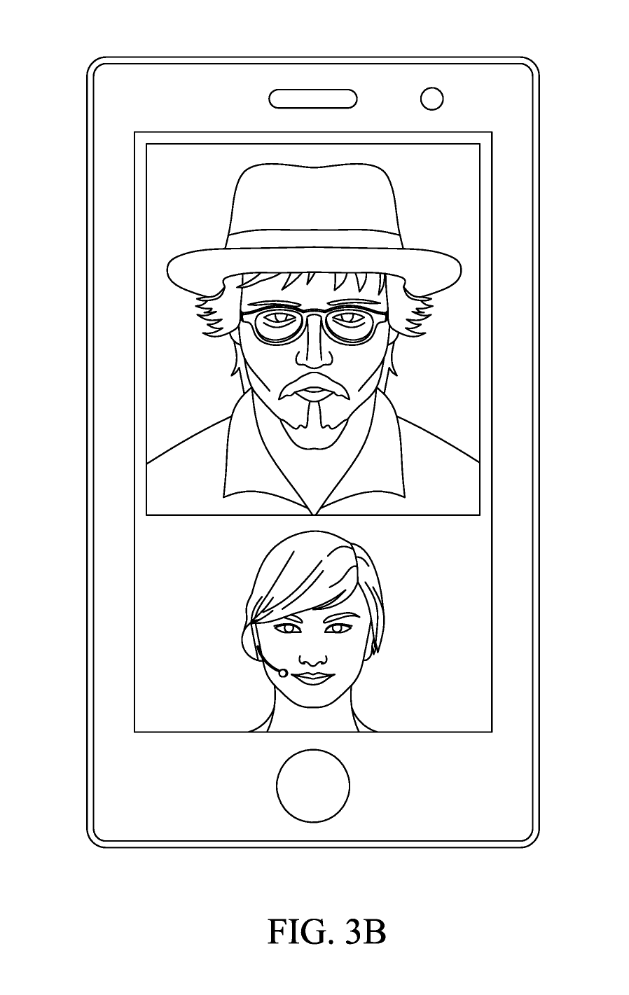

Referring to FIGS. 3A and 3B, the online customer service system 1 shows the schematics for merging the virtual image and the real image in the video frame of the handheld device. The schematics of FIGS. 3A and 3B are shown in the handheld device of the visitor 41. That is, the upper part of the video frame shows the image of the visitor 41 and the lower part of the video frame shows the image of the customer service staff 211. Video of the aforementioned interaction mechanisms includes merging real time virtual image and real image on a video frame. In details, while the customer service staff 211 of the website operator A such as clothing company interacts with the visitor 41, the customer service staff 211 can immediately merge and show the image of clothes and the image of the visitor 41 in the video frame of the handheld device of the visitor 41, as shown is FIG. 3B. In other words, the customer service staff 211 can merge the real image (the image of the visitor in the video frame) with the virtual images (for example, the image of the hat) so that the visitor 41 can immediately see himself or herself wearing the clothes, the hat, or the watch, and so forth (merging image). Furthermore, the virtual images include clothes, shoes, hats, watches and so forth, which are stored as the objects in the database.

In summary, the method of Internet real-time customer service of the present invention provides the features of: by providing an online customer service system 1 so that website operators A, B, C can initiate interaction with visitors 41, 42, 43 visiting websites (A website 21, B website 22, C website 23) to offer assistance, answer, in-depth explanation and services so as to achieve invigorating the website to change the potential customer into actual customers. In addition, customer service staff 211, 221, 231 of website operators A, B, C can also use wireless access to internet of mobile phone to the connect to online customer service system 1 to interact with visitors.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A method of Internet real-time customer service, which comprises:
providing an online customer service system by a handheld device, which is connected to Internet;
providing an exclusive login data including a login source code and an login executable file to a website operator registering to the online customer service system;
customer service staff of the website operator using the exclusive login data to log in to the online customer service system for the online customer service system by the handheld device to enable the customer service staff of the website operator to monitor the website by the handheld device; and
when a visitor visits website, the online customer service system providing a plurality of interaction channels between the customer service staff and the visitor as the basis of interaction so that the customer service staff and the visitor able to select from a plurality of interaction channels for interacting with each other;
wherein after the website operator adds the login source code to the website operator's own web page program code, the website operator logs in and connects to the online customer service system for the first time by the handheld device; the online customer service system enables the customer service staff of the website to monitor the website by the handheld device, and the website operator can use web page to directly log in to the online customer service system by the handheld device subsequently;
wherein the website operator can log in to the online customer service system by executing the login executable file;
wherein the handheld device includes a mobile computing device, a portable computing device, a smart phone or a tablet computer;
wherein the plurality of interaction channels further comprises a first interaction channel, a second interaction channel and a third interaction channel; the first interaction channel is for the customer service staff to initiate sending an interaction invitation to the visitor to the website; the interaction invitation appears as a dialog box to the visitor; the online customer service system waits for the visitor to respond; when the visitor accepts the interaction invitation, the online customer service system automatically switches to the second interaction channel; the second interaction channel is for customer service staff and visitor to conduct interaction; the interaction further comprises a plurality of interaction mechanisms; the customer service staff and visitor can select at least one from the plurality of interaction mechanism to conduct interaction; the third interaction channel is established in the website by the online customer service system in the format of an icon; when the visitor visiting the website clicks on the icon, the online customer service system allows the customer service staff and the visitor to conduct interaction; the interaction further comprises a plurality of interaction mechanisms; the customer service staff and visitor can select at least one from the plurality of interaction mechanism to conduct interaction;
wherein the plurality of interaction mechanisms further comprises: text, audio, image, video, file transfer, customer service staff transfer real time and real time virtual image and real image merging on a video frame;
wherein the text of the interaction mechanisms includes real time language interpretation between the customer service staff and the visitor;
wherein the audio of the interaction mechanisms includes auto play voice message from the visitor on the handheld device of the customer service staff;
wherein the customer service staff transfer real time of the interaction mechanisms includes real time text transfer from the handheld device of one customer service staff to the handheld device of another customer service staff.

2. The method as claimed in claim 1, wherein the online customer service system further comprises at least a database; the online customer service system can record and store IP address of the visitor when visiting the website and interaction contents through the interaction mechanism to the database.

3. The method as claimed in claim 1, wherein the visitor visits the website through an electronic device including a desktop computer, a notebook computer, a tablet computer, or a smart phone.

4. The method as claimed in claim 2, wherein the real image includes an image of the visitor in the video frame of the handheld device and the virtual image includes an image of at least one object stored in the database of the handheld device.
